(19) United States
(12) Patent Application Publication
(10) Pub. No.: US 2025/0222435 A1
(43) Pub. Date: Jul. 10, 2025

(54) PROCESS FOR PRODUCING LITHIUM SELECTIVE ADSORBENTS USING A STOICHIOMETRIC AMOUNT OF LITHIUM

(71) Applicant: ILIAD IP COMPANY, LLC, Carlsbad, CA (US)

(72) Inventor: Charles R. Marston, Midland, MI (US)

(73) Assignee: ILIAD IP COMPANY, LLC, Carlsbad, CA (US)

(21) Appl. No.: 19/016,525

(22) Filed: Jan. 10, 2025

Related U.S. Application Data
(60) Provisional application No. 63/619,711, filed on Jan. 10, 2024.

(51) Int. Cl. B01J 20/30; B01J 20/04

(52) U.S. Cl. CPC B01J 20/3085; B01J 20/041; B01J 20/3078

(57) ABSTRACT

This invention generally relates to a process for producing lithium aluminum double hydroxide (LADH) lithium selective adsorbents, which uses an intercalation reaction liquor having a stoichiometric amount of lithium to intercalate an adsorbent precursor or a spent LADH adsorbent, and thereby produce an intercalated layered aluminate adsorbent. The intercalated layered aluminate adsorbent is neutralized using an acid at a predetermined neutralization temperature to produce the lithium selective adsorbent. The stoichiometric amount of lithium used in the intercalation reaction liquor is less than about 10 lb. lithium per cubic foot of the lithium selective adsorbent.

### CROSS-REFERENCE TO RELATED APPLICATIONS

This application claims the benefit of and priority to U.S. Provisional Patent Application No. 63/619,711 filed on Jan. 10, 2024, and incorporates the provisional application by reference in its entirety into this document as if fully set out at this point.

### BACKGROUND OF THE INVENTION

### 1. Field of the Invention

The subject matter disclosed herein relates to a process for producing lithium selective adsorbents using a stoichiometric amount of lithium.

### 2. Description of the Related Art

The growing demand for lithium in various applications, particularly lithium-ion batteries, means that lithium-bearing brines are becoming increasingly attractive as new energy resources. Consequently, there is a growing demand for effective lithium selective adsorption media for direct lithium extraction (DLE), particularly aluminum-based adsorbent products.

Lithium salts are required in significant quantities for the production of lithium aluminum double hydroxide (“LADH”). In traditional manufacturing processes, excess lithium salts are employed to drive intercalation processes to produce lithium selective adsorbents for lithium recovery. Conventional adsorbent formulations rely on super-stoichiometry (i.e., excess lithium) to drive the conversion of Al(OH)₃ to the lithium selective adsorption media. More specifically, conventional adsorbent formulations require super-stoichiometry (e.g., between 20 and 50 lb. of lithium per cubic foot of finished adsorbent) to drive the conversion of Al(OH)₃ to the lithium selective adsorption media. In these traditional manufacturing methods, unsupported alumina is first converted, then later formulated into a column-ready particle format. Only after incorporation in an adsorbent does the adsorbent volume become calculatable. As a result, the final adsorbent's Li mass-to-adsorbent volume ratio is relatively low, and the methods do not account for reversible lithium capacity.

In addition, LADH adsorbents are sensitive to operating conditions and can be damaged by over-deintercalation or simply spent by usage or aging. These columns, therefore, suffer from several drawbacks, such as shortened lifetimes due to the gradual deterioration and disintegration of the particles and collapse of the crystal structures.

In the recovery of lithium from brines, the primary mode of aging, performance degradation, and failure of LADH adsorbents is via over-deintercalation, which occurs when the LADH adsorbent undergoes numerous adsorption/desorption cycles and/or extended deintercalation times or is deintercalated (or stripped) of lithium using a deintercalation solution having no, or too little, latent lithium (i.e., less than about 150 ppm). Over-deintercalation causes the LADH in the adsorbent to expel the lithium cation and its counterion from its characteristic layered structure, destroying the lithium adsorption site and the adsorbent's ability to rapidly intercalate and elute lithium salts with high selectivity. It has been found that spent, aged, or damaged LADH adsorbents were final and irreversible, limiting the useful lifetime of LADH adsorbents and making many LADH adsorbents non-economic media for commercial lithium recovery. The use of excess lithium salts in these traditional methods results in lithium losses. Additional expenses must also be incurred to purchase new lithium salts or to recapture and reuse lithium salts from previous rounds of lithium recovery. The market price of lithium salts, therefore, strongly influences the overall cost of manufacturing lithium selective adsorbents. At the commercial scale, without reducing the amount of lithium salt used in subsequent intercalation, the lost lithium salt could be non-economical, and waste management could be costly.

### SUMMARY OF THE INVENTION

The invention relates to a process for producing lithium selective adsorbents containing LADH using a stoichiometric amount of lithium. A need exists to minimize the mass of lithium salts used in the commercial-scale production and regeneration of lithium selective adsorbents for DLE applications in order to improve the economics of production. With the increasing value of lithium in the marketplace and the drive toward zero discharge at production facilities, the inventive process improves the economic and environmental impact of manufacturing and regenerating lithium selective adsorbents by reducing the amount of lithium (from e.g., lithium salt, alkali) used in the process.

The inventive process for producing a lithium selective adsorbent containing LADH uses an optimized quantity of lithium with improved lithium-to-aluminum stoichiometry. Compared to traditional formulation methods, the inventive process performs intercalation with comparatively less lithium to produce highly active lithium selective adsorbents. This improved lithium-to-aluminum stoichiometry minimizes lithium waste (thereby contributing to zero discharge goals for manufacturing), eliminates the economic need to recover and recycle lithium from the reaction liquor for subsequent reuse, and creates significant lithium savings and related cost savings in commercial production. These non-limiting exemplary advantages are extremely important when manufacturing hundreds of thousands of pounds of lithium adsorbent.

Accordingly, it is an object of this invention to provide a process that quickly and efficiently produces a LADH lithium selective adsorbent using a stoichiometric amount of lithium.

In general, in a first aspect, the invention relates to a process for producing a lithium selective adsorbent. The process intercalates an adsorbent precursor or a spent lithium selective adsorbent with an intercalation reaction liquor having a stoichiometric amount of lithium to produce an intercalated layered aluminate adsorbent, which is neutralized using an acid to produce the lithium selective adsorbent. The stoichiometric amount of lithium is less than about 10 lb. lithium per cubic foot of the lithium selective adsorbent.

In an embodiment, the stoichiometric amount of lithium can be from about 4 lb. lithium per cubic foot of the lithium selective adsorbent to less than about 10 lb. lithium per cubic foot of the lithium selective adsorbent (and any range or value therebetween), and more particularly, between about 7 lb. lithium per cubic foot of the lithium selective adsorbent and about 9 lb. lithium per cubic foot of the lithium selective adsorbent, and more particularly, about 7 lb. lithium per cubic foot of the lithium selective adsorbent.

In an embodiment, the step of intercalating the adsorbent precursor or the spent LADH adsorbent is performed at a predetermined intercalation temperature between about 25° C. and about 125° C. (and any range or value therebetween), and more particularly, between about 85° C. and about 105° C. or greater than 100° C. to about 105° C.

In an embodiment, the step of intercalating the adsorbent precursor or the spent LADH adsorbent can be performed under alkaline conditions, where the intercalation reaction liquor can include a lithium salt, an alkali, or both in a brine.

In an embodiment, the stoichiometric amount of lithium includes lithium from the lithium salt. The lithium salt can be LiCl, LiBr, LiI, LiOH, Li₂SO₄, Li₂CO₃, LiNO₃, or a mixture thereof, and more particularly, the lithium salt can be LiCl or LiOH.

In an embodiment, the brine contains a majority of chloride salts, and can be NaCl, NaBr, NaNO₃, KCl, KBr, or a mixture thereof, and more particularly, the brine can be KCl or NaCl.

In an embodiment, the alkaline conditions can have an alkaline pH from about 7 to about 13 (and any range or value therebetween), and more particularly, between about 9 and about 12.

In an embodiment, the alkali can be an alkali hydroxide, an alkaline earth metal hydroxide, a strong base, a monoacid base, ammonia, or a mixture thereof. The alkali can be KOH, NaOH, LiOH, or a mixture thereof, and more particularly, the alkali can be NaOH or LiOH.

In an embodiment, the brine is NaCl, the lithium salt is LiCl, and the alkali is NaOH.

In an embodiment, the stoichiometric amount of lithium includes lithium from the lithium salt and/or from the alkali in the brine.

In an embodiment, the lithium salt is LiOH, and the alkali is LiOH.

In an embodiment, the brine is KCl, the lithium salt is LiOH, and the alkali is LiOH.

In an embodiment, the step of intercalating the adsorbent precursor can also include intercalating the adsorbent precursor or the spent LADH adsorbent by heating to a predetermined intercalation temperature for a predetermined amount of intercalation time. The predetermined amount of intercalation time can be between about 0.375 hours and about 390 hours (and any range or value therebetween), and more particularly, greater than 100 hours to about 390 hours, and more particularly, between about 1.5 hours and about 6 hours.

In an embodiment, the step of neutralizing the intercalated layered aluminate adsorbent can include neutralizing the intercalated layered aluminate adsorbent at a predetermined neutralization temperature between about 25° C. and about 115° C. (and any range or value therebetween), and more particularly, between about 65° C. and about 80° C., and more particularly, greater than 70° C. to about 80° C.

In an embodiment, the step of neutralizing the intercalated layered aluminate adsorbent can also include neutralizing the intercalated layered aluminate adsorbent under acidic conditions. The acidic conditions can have an acidic pH from about 4.5 to about 7 (and any range or value therebetween), and more particularly, between about 5.4 and about 6.5 or between about 5 and about 5.8.

In an embodiment, the acid is a strong acid, a mineral acid, a sulfonic acid, a carboxylic acid, or a mixture thereof. The acid can be hydrochloric acid, sulfuric acid, nitric acid, phosphoric acid, hydrobromic acid, perchloric acid, formic acid, acetic acid, or a mixture thereof, and more particularly, the acid can be acetic acid. The acid can have a concentration of between about 5% and about 100% (and any range or value therebetween).

In an embodiment, the step of neutralizing the intercalated layered aluminate adsorbent can include neutralizing the intercalated layered aluminate adsorbent for a predetermined amount of neutralization time.

In an embodiment, the predetermined amount of neutralization time can be between about 0.03125 hours and about 16 hours (and any range or value therebetween), particularly less than 2 hours, and more particularly, between about 0.25 hours and about 1 hours.

In an embodiment, the process can include producing the adsorbent precursor by forming aluminum hydroxide (Al(OH)₃) crystals in situ within pores of an ion exchange resin. The pores of the ion exchange resin can be impregnated with an aluminum chloride (AlCl₃) solution, and then the AlCl₃ impregnated resin is infiltrated with alkali to form Al(OH)₃ microcrystal seeds within the pores of the ion exchange resin. The Al(OH)₃ seeded resin is infiltrated with an alkaline aluminate solution, and an acid is used to remove excess NaOH produced in the Al(OH)₃ microcrystal seeds formation.

In an embodiment, the ion exchange resin can be a polystyrene-based ion exchange resin, and more particularly, an organic, porous polystyrene-based ion exchange resin bead. In an embodiment, the ion exchange resin is functionalized as a strong base anion (SBA) or a weakly basic anion (WBA) exchange resin, and the WBA exchange resin can be in an HCl form before the step of impregnating the pores of the ion exchange resin with the AlCl₃ solution.

In general, in a second aspect, the invention relates to a lithium selective adsorbent manufactured by the process in the first aspect.

In general, in a third aspect, the invention relates to a lithium aluminum double hydroxide (LADH) lithium selective adsorbent produced by the process in the first aspect.

In general, in a fourth aspect, the invention relates to a process for producing a lithium selective adsorbent. The process includes intercalating an adsorbent precursor or a spent LADH adsorbent under alkaline conditions at a predetermined intercalation temperature using an intercalation reaction liquor having a stoichiometric amount of lithium to produce an intercalated layered aluminate adsorbent and a post-intercalation reaction volume of a partially depleted intercalation reaction liquor. The intercalation reaction liquor includes a lithium salt and an alkali in a brine, where the intercalation temperature is between about 25° C. and about 125° C. (and any range or value therebetween), and where the alkaline conditions include an alkaline pH from about 7 to about 13 (and any range or value therebetween). The post-intercalation reaction volume of the partially depleted intercalation reaction liquor is decanted from the intercalated layered aluminate adsorbent to obtain a decanted intercalation reaction liquor. The process also includes neutralizing the intercalated layered aluminate adsorbent under acidic conditions using an acid at a predetermined neutralization temperature to produce the lithium selective adsorbent, where the neutralization temperature is between about 25° C. and about 115° C. (and any range or value therebetween), and where the acidic conditions include a pH from about 4.5 to about 7. The decanted intercalation reaction liquor is augmented by adding a makeup volume to reconstitute the pre-intercalation reaction volume and to obtain an augmented intercalation reaction liquor, where the makeup volume includes a makeup lithium salt, a makeup alkali, and a makeup brine. The augmented intercalation reaction liquor is recycled in preparation for intercalating a subsequent quantity of the alumina-bearing adsorbent precursor or spent LADH adsorbent. The stoichiometric amount of lithium is from about 4 lb. lithium per cubic foot of the lithium selective adsorbent to less than about 10 lb. lithium per cubic foot of the lithium selective adsorbent.

In an embodiment, the stoichiometric amount of lithium can be between about 7 lb. lithium per cubic foot of the lithium selective adsorbent and about 9 lb. lithium per cubic foot of the lithium selective adsorbent, and more particularly, about 7 lb. lithium per cubic foot of the lithium selective adsorbent.

In an embodiment, the stoichiometric amount of lithium includes lithium from the lithium salt.

In an embodiment, the stoichiometric amount of lithium includes lithium from the lithium salt and the alkali.

In an embodiment, the lithium salt can be LiCl, LiBr, LiI, LiOH, Li₂SO₄, Li₂CO₃, LiNO₃, or a mixture thereof. The alkali can be KOH, NaOH, LiOH, or a mixture thereof. The brine can be NaCl, NaBr, NaNO₃, KCl, KBr, or a mixture thereof. The acid can be hydrochloric acid, sulfuric acid, nitric acid, phosphoric acid, hydrobromic acid, perchloric acid, formic acid, acetic acid, or a mixture thereof.

In an embodiment, the lithium salt is LiCl, the alkali is NaOH, the brine is NaCl, and the acid is acetic acid.

In an embodiment, the lithium salt is LiOH, the alkali is LiOH, the brine is KCl, and the acid is acetic acid.

In an embodiment, the makeup lithium salt can be LiCl, LiBr, LiI, LiOH, Li₂SO₄, Li₂CO₃, LiNO₃, or a mixture thereof. The makeup alkali can be KOH, NaOH, LiOH, or a mixture thereof. The makeup brine can be NaCl, NaBr, NaNO₃, KCl, KBr, or a mixture thereof.

In an embodiment, the makeup lithium salt is LiCl, the makeup alkali is NaOH, and the makeup brine is NaCl.

In an embodiment, the makeup lithium salt is LiOH, the makeup alkali is LiOH, and the makeup brine is KCl.

In an embodiment, the step of intercalating the adsorbent precursor or the spent LADH adsorbent can also include intercalating the adsorbent precursor or the spent LADH adsorbent by heating to the predetermined intercalation temperature for a predetermined amount of intercalation time, where the predetermined amount of intercalation time can be between about 0.375 hours and about 390 hours (and any range or value therebetween). The step of neutralizing the intercalated adsorbent can also include neutralizing the intercalated layered aluminate adsorbent for a predetermined amount of neutralization time between about 0.03125 hours and about 16 hours (and any range or value therebetween).

In an embodiment, the process can include producing the adsorbent precursor by forming aluminum hydroxide (Al(OH)₃) crystals in situ within pores of an ion exchange resin. The pores of the ion exchange resin can be impregnated with an aluminum chloride (AlCl₃) solution, and then the AlCl₃ impregnated resin is infiltrated with alkali to form Al(OH)₃ microcrystal seeds within the pores of the ion exchange resin. The Al(OH)₃ seeded resin is infiltrated with an alkaline aluminate solution, and an acid is used to remove excess NaOH produced in the AI (OH) 3 microcrystal seeds formation.

In an embodiment, the ion exchange resin can be a polystyrene-based ion exchange resin, and more particularly, an organic, porous polystyrene-based ion exchange resin bead. In an embodiment, the ion exchange resin is functionalized as a strong base anion (SBA) or a weakly basic anion (WBA) exchange resin, and the WBA exchange resin can be in an HCl form before the step of impregnating the pores of the ion exchange resin with the AlCl₃ solution.

In an embodiment, the process is performed at a chemical regeneration facility, an on-site mineral extraction facility, in a mobile reintercalation circuit, or within adsorbent columns of a direct lithium extraction circuit.

In an embodiment, the direct lithium extraction circuit comprises fixed beds, stirred tanks, pseudo- or simulated moving bed (SMB) circuits, or other DLE circuits.

### BRIEF DESCRIPTION OF THE DRAWINGS

The above and other objects and advantages of this invention may be more clearly seen when viewed in conjunction with the accompanying drawing wherein:

FIG. 1 is a process flow diagram for an exemplary process for producing a LADH lithium selective adsorbent with a stoichiometric amount of lithium in accordance with an illustrative embodiment of the invention disclosed herein.

FIG. 2 is a process flow diagram for another exemplary process of producing a LADH lithium selective adsorbent with a stoichiometric amount of lithium in accordance with an illustrative embodiment of the invention disclosed herein.

FIG. 3 is a process flow diagram for another exemplary process of producing a LADH lithium selective adsorbent by recycling and augmenting an intercalation reaction liquor with a stoichiometric amount of lithium in accordance with an illustrative embodiment of the invention disclosed herein.

FIG. 4 graphically illustrates lithium loading provided by stoichiometry of an illustrative embodiment of the invention disclosed herein.

FIG. 5 graphically illustrates lithium loading provided by an illustrative embodiment of the invention disclosed herein.

FIG. 6 graphically illustrates lithium loading provided by an illustrative embodiment of the invention disclosed herein.

### DETAILED DESCRIPTION OF THE INVENTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

Generally, lithium aluminum double hydroxide (LADH) lithium selective adsorbents are manufactured from microcrystalline, hydrated aluminum trihydroxides (Al(OH)₃) (e.g., Gibbsite, and its common polymorphs, Boehmite, Bayerite, and Nordstrandite) by heating the hydrated alumina precursor with one or more lithium salts at an elevated pH using alkali chemicals, such as hydroxide salts of sodium, lithium, or potassium. As used herein, Gibbsite includes its common polymorphs, Boehmite, Bayerite, and Nordstrandite.

The lithium selective adsorbent has an inorganic composition. The term “inorganic,” as used herein, refers to those compositions not containing carbon or wherein carbon is present but in its elemental state. Typically, the inorganic composition includes at least one metal, wherein the term “metal,” as used herein, includes traditionally defined metals as well as metalloids (those elements having both metallic and non-metallic properties and which overlap with the main group elements). The inorganic composition can be or can include a metal oxide composition, such as silica, Gibbsite, alumina, (e.g., alumina, θ-Al₂O₃, χ-Al₂O₃, κ-Al₂O₃, ε-Al₂O₃, δ-Al₂O₃, AlO(OH), pseudoboehmite, or a combination thereof) or an aluminosilicate, such as a zeolite, e.g., MFI-type, MEL-type, MTW-type, MCM-type, BEA-type, faujasite, or ZSM-type zeolites. The metal oxide composition may alternatively be or include, for example, zirconium oxide, yttrium oxide, titanium oxide, cerium oxide, chromium oxide, copper oxide, nickel oxide, or hafnium oxide, or a combination thereof.

The inorganic composition can include a metal carbide composition, such as silicon carbide, iron carbide (e.g., steel), tungsten carbide, titanium carbide, molybdenum carbide, or boron carbide, or combination thereof.

The inorganic composition can include a metal nitride composition, such as boron nitride, silicon nitride, silicon oxynitride, silicon carbide nitride, aluminum nitride, tantalum nitride, or zirconium nitride, or combination thereof. Alternatively, the inorganic composition can include a metal boride composition, such as aluminum boride, titanium boride, cobalt boride, tantalum boride, or magnesium boride, or combination thereof. The inorganic composition can also include a ceramic composition, which may be an oxide, carbide, nitride, or boride material.

The support for the lithium selective adsorbent can be a polymer, for example, a polyimide, polyether ether ketone (PEEK), polybenzimidazole, ionomer (e.g., sulfonated tetrafluoroethylene, such as Nafion®), polysiloxane (e.g., a silicone rubber or foam), polyurethane, polycarbonate, polyethyleneimine (PEI), polyester (e.g., polyethylene terephthalate), polyamide (e.g., a nylon), vinyl addition polymer (e.g., polyvinylchloride, polyethylene, polypropylene, polystyrene or a fluoropolymer, such as PVDF or PTFE), a mixture of polymers or a copolymer that includes one or more of any of the foregoing polymers. The polymer may alternatively be a composite that includes at least one of the foregoing polymers, wherein the composite includes separate regions (e.g., layers) of polymers of different compositions. The polymer may alternatively be an ion exchange resin bead, pellet, irregularly shaped particle from course media grinding, membrane, or porous ceramics and molecular sieves.

As used herein, the lithium selective adsorbent can have any of the lithium aluminum intercalate LADH forms known in the art, such as lithium aluminum layered double hydroxide chloride (LiCl·2Al(OH)₃), Gibbsite-based lithium aluminum layered double hydroxide, lithium aluminum intercalate (LiAl₂(OH)₆Cl) (“LADH”) crystals in microporous, polymeric resin beads or other suitable adsorbent support noted above.

The invention disclosed herein is directed to a process for manufacturing a lithium selective adsorbent containing LADH using an intercalation reaction liquor with a stoichiometric amount of lithium. As used herein, the term “stoichiometric” encompasses quantities of reactants in simple integral ratios, as prescribed by an equation or formula, +10% of the base value.

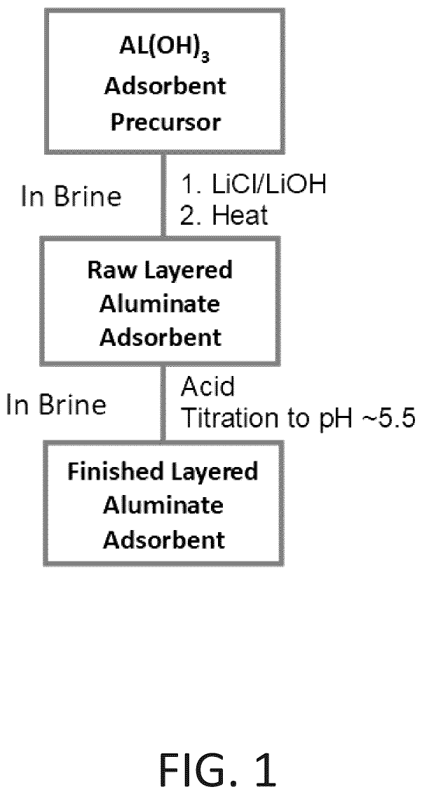

FIG. 1 illustrates an exemplary process flow diagram for the inventive manufacturing process for manufacturing a LADH lithium selective adsorbent. As exemplified, the inventive manufacturing process grows lithium aluminum intercalate (LiAl₂(OH)₆Cl) crystals (e.g., provides an alumina-based or Gibbsite-bearing adsorbent precursor) in situ within open cavities of an organic, porous ion exchange resin. Utilizing the existing internal pore structure of ion exchange resin allows for the formation of Al(OH)₃, and subsequently the LADH, in the confines of pores. This manufacturing process minimizes the potential loss of the aluminum to fragmentation or even dissolution while also assuring the physical stability of the finished adsorbent and its suitability for long-term packed bed service. The porous ion exchange resin is seeded with hydrous crystalline alumina by initially impregnating the pores of the organic ion exchange resin beads with aluminum chloride (AlCl₃) solution. Aluminum chloride forms a Lewis Acid/Lewis Base complex with electron-rich functionality within the pores. Suitable ion exchange resins include a dimethylamine functionalized chloromethylated copolymer of styrene and divinylbenzene and a polystyrene-based ion exchange resin, and, more particularly, an organic, porous polystyrene-based ion exchange resin bead. The ion exchange resin may be functionalized as a strong base anion (SBA) or a weakly basic anion (WBA) exchange resin, and the WBA exchange resin can be in an HCl form before the step of impregnating the pores of the ion exchange resin with the AlCl₃ solution.

The AlCl₃-impregnated resin beads are then infiltrated with an alkali (e.g., ammonia, sodium hydroxide or lithium hydroxide), thereby forming aluminum hydroxide (Al(OH)₃) (e.g., Gibbsite) microcrystals (seeds) on the surface of the internal pores of the resin beads. Equation 1 demonstrates an exemplary embodiment of this reaction.

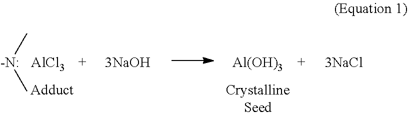

Aluminum hydroxide microcrystal seed formation is followed by infiltration with an alkaline aluminate solution (e.g., sodium aluminate), and an acid is used to remove excess NaOH produced in the crystalline reformation of Al(OH)₃ in situ generally as Gibbsite within the pores of the beads. The seeds of hydrous crystalline alumna within the pores are used as growth sites for producing additional crystallized Al(OH)₃ with alkaline aluminate solution treatments. Equation 2 demonstrates an exemplary embodiment of this reaction.

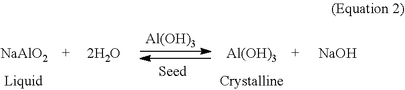

The inventive manufacturing process then intercalates the crystalline hydrous alumina in the pores to LADH by treating the Al(OH)₃ loaded resin beads with a stoichiometric amount of lithium salt (e.g., LiCl) in a stoichiometrically dilute brine with alkaline conditions at a predetermined elevated intercalation temperature. The inventive intercalation process is generally performed with a stoichiometric amount of lithium driving the reaction forming LADH from Gibbsite. An exemplary embodiment of this reaction is outlined by Equation 3.

LₙX+2ₙAl(OH)₃+pH₂O=[LiAl₂(OH)₆]ₙX·pH₂O(LADH-X) (Equation 3)
where X=Cl⁻, Br⁻, I⁻, OH⁻, SO₄²⁻, CO₃²⁻, NO₃⁻

Once intercalated with lithium, the LADH adsorbent, more particularly the hydroxyl counterion of the freshly formed LADH adsorbent, is neutralized with an appropriate acid. In one embodiment, a weak acid such as acetic acid in the presence of NaCl brine is employed for the neutralization to minimize dissolution of the newly formed LADH. Subsequent NaCl brine washing assures that the LADH is in the chloride form when placed in DLE service.

As noted above, the primary mode of aging, performance degradation, and failure of LADH adsorbents is via complete deintercalation or over-stripping, which occurs when the LADH adsorbent undergoes numerous adsorption/desorption cycles, extended deintercalation times, or is deintercalated of lithium using a deintercalation solution having no, or too little, latent lithium (i.e., less than about 150 ppm). Complete deintercalation or over-stripping causes the LADH in the adsorbent to expel the lithium cation and its counterion from its characteristic layered structure, destroying the lithium adsorption site and the adsorbent's ability to rapidly intercalate and elute lithium salts with high selectivity. An exemplary embodiment of this intercalation reaction is outlined in Equation 4.

[LiAl₂(OH)₆]ₙX·pH₂O+aq→2nAl(OH)₃+LiₙX (Equation 4)

The invention disclosed can also be used for reintercalating spent (e.g., deintercalated) lithium selective adsorbents. The inventive process can be performed to reintercalate the adsorbent and can be performed multiple times over the life of the adsorbent. The reintercalation process can be conducted at a chemical regeneration facility, or alternatively, in situ, such as at an on-site mineral extraction facility, in a mobile reinteractation circuit, or within adsorbent columns of a lithium extraction (e.g., DLE) circuit. In the later arrangement, this invention can be used in fixed beds, stirred tanks, pseudo- or simulated moving bed (SMB) circuits, or other DLE circuits (including continuous countercurrent adsorption and desorption circuits having rotary or indexing multi-port valve systems) and may take advantage of existing piping and pump arrangements. Depending on the properties of the brine solution being processed, mobile or dedicated reagent tanks may be added to the existing infrastructure in various embodiments.

As used herein, “spent” includes deintercalated, aged, damaged, degraded, depleted, exhausted, or otherwise over-stripped lithium selective adsorbents, and “reintercalating” includes regenerating, rejuvenating, reconditioning, renovating, repairing, or otherwise intercalating spent lithium selective adsorbents.

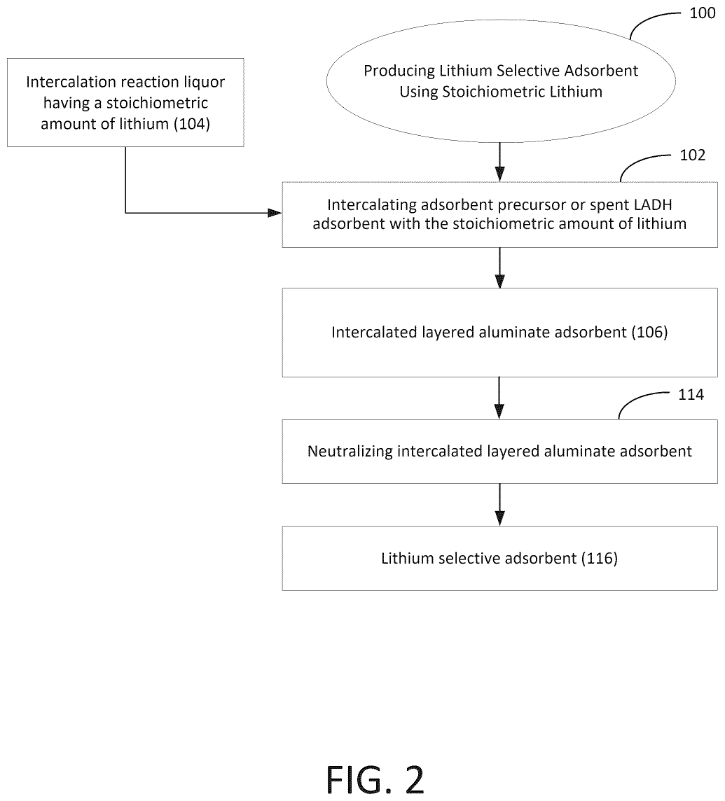

FIG. 2 illustrates an exemplary process flow diagram for the inventive process 100 for producing a lithium selective adsorbent. An adsorbent precursor or a spent LADH lithium selective adsorbent is intercalated (step 102) with lithium under alkaline conditions at a predetermined intercalation temperature using an intercalation reaction liquor 104. The intercalation reaction liquor 104 includes a lithium salt and an alkali in a brine. More particularly, the intercalation reaction liquor 104 includes a stoichiometric amount of lithium in the brine. In one embodiment, the adsorbent precursor spent LADH lithium selective adsorbent is intercalated by heating to the predetermined intercalation temperature in the presence of the lithium salt in the brine under the alkaline conditions for a predetermined amount of intercalation time.

When converting latent Al(OH)₃ to LADH in-situ, the aluminum content determines the lithium charge required for the completion of the reaction. As shown in Equation 3, the stoichiometry for the lithium intercalation reaction has a 2:1 in Al:Li ratio. Alumina imbibed ion exchange resins generally contain 8-14% aluminum by dry weight (wt.). In the finished state aluminum loading is 1.1 to 2.0 mol/L. If the aluminum content of the adsorbent is known, the stoichiometric charge of lithium for Equation 3 can easily be calculated, as demonstrated in Table 1.

TABLE 1
Calculating Stoichiometric Charge of Lithium Salts.

| Aluminum imbibed resin | LiCl lb./cuft | LiOH•H₂O lb./cuft |
|---|---|---|
| Al % dry wt. | at stoichiometric | at stoichiometric |
| 7% | 5.0 | 4.9 |
| 8% | 5.7 | 5.6 |
| 9% | 6.4 | 6.3 |
| 10% | 7.1 | 7.0 |
| 11% | 7.8 | 7.7 |
| 12% | 8.5 | 8.4 |
| 13% | 9.2 | 9.1 |
| 14% | 10.0 | 9.8 |

The stoichiometric amount of lithium in the intercalation reaction liquor may include lithium from the lithium salt, the alkali, or both. The lithium salt can be LiCl, LiBr, LiI, LiOH, Li₂SO₄, Li₂CO₃, LiNO₃, or a mixture thereof. For the alkaline conditions of step 102, the alkali in the intercalation reaction liquor 104 yields an alkaline pH from about 7 to about 13 (and any range or value therebetween), and more particularly, a pH between about 9 and about 12. Suitable alkalis include alkali hydroxides, alkaline earth metal hydroxides, strong bases, monoacid bases, ammonia, and mixtures of the same. Without limitation, the alkali can be hydroxides of potassium (KOH), sodium (NaOH), lithium (LiOH), or of other alkali or alkaline earth metals, other suitable strong or monoacid bases, ammonia (potentially from urea thermal decomposition), or a mixture thereof. Due to the elevated charge of LiOH, the use of LiOH as the source of alkali provides more alkalinity than is normally applied during the lithium intercalation reaction as aluminum hydroxide compounds are transformed to LADH. The dilute brine used for intercalation in step 102 can be NaCl, NaBr, NaNO₃, KCl, KBr, or a mixture thereof, and other dilute brines preferably containing a majority of chloride salts. In one non-limiting embodiment, the lithium salt includes LiOH, the alkali includes NaOH, and the dilute brine includes NaCl; in this embodiment, the lithium salt contributes to the stoichiometric amount of lithium but the alkali does not. In another non-limiting embodiment, the dilute brine includes KCl, NaCl, or both, while the lithium salt and the alkali are both LiOH; in this embodiment, both the lithium salt and the alkali contribute to the stoichiometric amount of lithium in step 102.

The predetermined elevated intercalation temperature for step 102 can be between about 25° C. and about 125° C. (and any range or value therebetween, including without limitation the values shown in Table 2 and the ranges therebetween), and more particularly, between about 85° C. and about 105° C. In one non-limiting embodiment, the intercalation temperature is greater than about 100° C. to about 105° C. As shown in Table 2, depending upon the intercalation temperature, the intercalation time can be between about 0.375 hours and about 390 hours (and any range or value therebetween, including without limitation the values shown in Table 2 and the ranges therebetween), particularly, between about 0.75 hours and about 390 hours, and more particularly, about 1.5 hours to about 6 hours. In one embodiment, the intercalation time is greater than about 100 hours to about 390 hours.

TABLE 2
Intercalation Time and Temperatures.

| | | | | | | | | | | | |
|---|---|---|---|---|---|---|---|---|---|---|---|
| Temperature (° C.) | 125 | 115 | 105 | 95 | 85 | 75 | 65 | 55 | 45 | 35 | 25 |
| Time (Hours) | 0.375 | 0.75 | 1.5 | 3 | 6 | 12 | 24 | 48 | 96 | 192 | 390 |

Turning back to FIG. 2, the resulting products of the intercalating step 102 include a post-intercalation reaction volume of a partially depleted intercalation reaction liquor 108 and an intercalated layered aluminate adsorbent 106, which is neutralized (step 114) under acidic conditions to an acidic pH of about 4.5 and about 7 (and any range or value therebetween), and more particularly, a pH between about 5.4 and about 6.5 or a pH between about 5 and about 5.8. The intercalated layered aluminate adsorbent 106 is neutralized using an acid at a predetermined neutralization temperature to produce the lithium selective adsorbent 116. The acid can be hydrochloric, sulfuric, nitric, phosphoric, hydrobromic, perchloric, formic, acetic, or other suitable strong, mineral, sulfonic, or carboxylic acids, or a mixture thereof. The acid can have a concentration of between about 5% and about 100% (and any range or value therebetween).

As shown by Table 3, the neutralization temperature for step 114 can range from about 25° C. to about 115° C. (and any range or value therebetween, including without limitation the values shown in Table 3 and the ranges therebetween), and more particularly, from between about 65° C. and about 80° C. In one embodiment, the neutralization temperature is greater than about 70° C. to about 80° C. Step 114 of neutralizing the intercalated layered aluminate adsorbent is performed for a predetermined amount of neutralization time, which can range between about 0.03125 hours and about 16 hours (and any range or value therebetween, including without limitation the values shown in Table 3 and the ranges therebetween), and more particularly, from between about 0.25 hours and about 1 hour. In one embodiment, the neutralization time is less than 2 hours.

TABLE 3
Neutralization Time and Temperatures.

| | | | | | | | | | | |
|---|---|---|---|---|---|---|---|---|---|---|
| Temperature (° C.) | 115 | 105 | 95 | 85 | 75 | 65 | 55 | 45 | 35 | 25 |
| Time (Hours) | 0.03125 | 0.0625 | 0.125 | 0.25 | 0.5 | 1 | 2 | 4 | 8 | 16 |

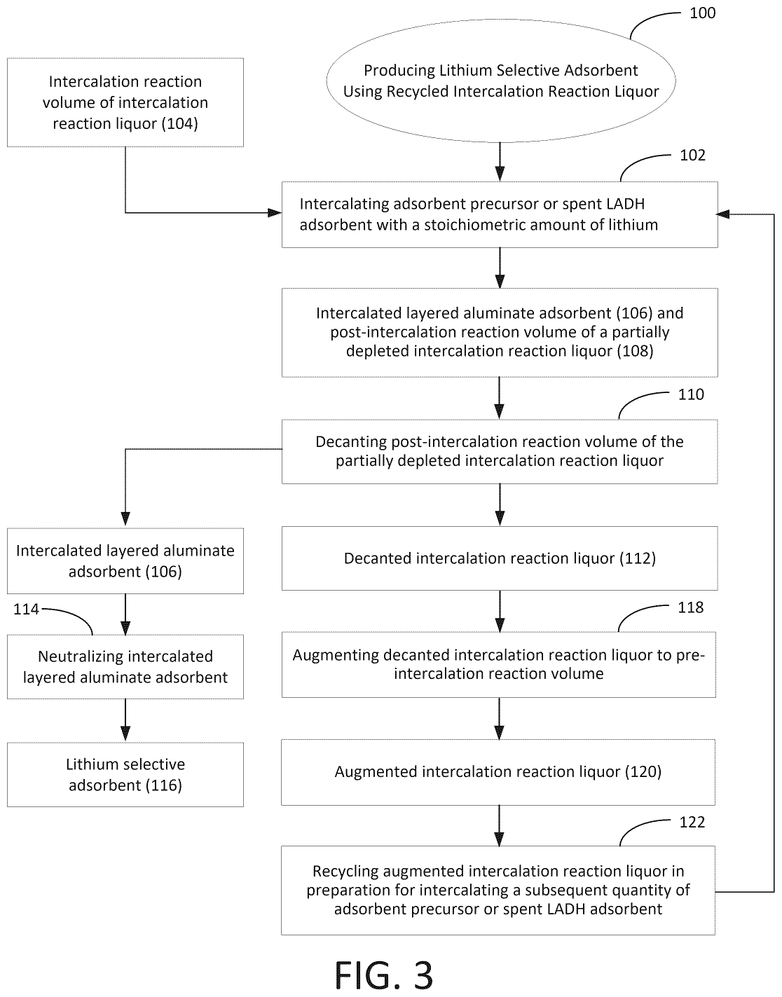

Turning to FIG. 3, the process 100 can include recycling the intercalation reaction liquor. In this embodiment, the post-intercalation reaction volume of the partially depleted intercalation reaction liquor 108 is decanted from the intercalated layered aluminate adsorbent 106 (step 110) to obtain a decanted intercalation reaction liquor 112. The decanted intercalation reaction liquor 112 is augmented (step 118) by adding a makeup volume to reconstitute the pre-intercalation reaction volume of the intercalation reaction liquor and to obtain an augmented intercalation reaction liquor 120. It will be appreciated that step 118 may occur before, after, or simultaneous with step 114. The makeup volume includes a makeup brine, a makeup lithium salt, a makeup alkali, or a mixture thereof. Suitable brines, lithium salts, and alkalis for augmenting the decanted intercalation reaction liquor in step 118 include those that are suitable for the intercalating step (step 102). The makeup brine, the makeup lithium salt, and/or the makeup alkali in step 118 may have the same or different components as the brine, the lithium salt, and the alkali used in step 102. Without limitation, the makeup brine may be NaCl, NaBr, NaNO₃, KCl, KBr, or a mixture thereof, and other dilute brines preferably containing a majority of chloride salts; the makeup lithium salt may be LiCl, LiNO₃, LiBr, LiOH, or a mixture thereof; and the makeup alkali may be KOH, NaOH, LiOH, or a mixture thereof. In one non-limiting embodiment, the makeup brine is NaCl, the makeup lithium salt is LiCl, and the makeup alkali is NaOH. In another non-limiting embodiment, the makeup lithium salt and the makeup alkali are both LiOH, where the makeup brine is optionally KCl.

The augmented intercalation reaction liquor 120 is recycled (step 122) in preparation for intercalating a subsequent quantity of alumina-based adsorbent precursor or spent LADH adsorbent (i.e., step 102 is repeated using the augmented intercalation reaction liquor 120 in place of the intercalation reaction liquor 104). This recycling may involve filtering the augmented intercalation reaction liquor 120, if necessary, prior to intercalating the subsequent quantity of alumina-based adsorbent precursor or spent lithium selective adsorbent. In one embodiment, steps 102, 110, 114, 118, and 122 are successively repeated until the intercalation reaction liquor is fully depleted or contains excess residual alumina such that the reaction no longer produces high-quality LADH adsorbents. In other non-limiting embodiments, steps 102, 110, 114, 118, and 122 are successively repeated up to about seven (7) times, up to about five (5) times, or up to about three (3) times.

The intercalation step 102 uses less than about 10 lb. lithium per cubic foot of the produced lithium selective adsorbent 116. In various embodiments, the intercalation step 102 uses between about 4 lb. lithium per cubic foot of the lithium selective adsorbent 116 (about 4 lb./cuft) and about 10 lb. lithium per cubic foot of the lithium selective adsorbent 116 (about 10 lb./cuft) (and any range or value therebetween), more particularly from about 4 lb./cuft to less than about 10 lb./cuft. In some embodiments, the stoichiometric amount of the lithium is between about 7 lb. lithium per cubic foot of the lithium selective adsorbent 116 (about 7 lb./cuft) and about 9 lb. lithium per cubic foot of the lithium selective adsorbent 116 (about 9 lb./cuft). In one embodiment, about 7 lb. of lithium per cubic foot of manufactured adsorbent 116 (about 7 lb./cuft) is used in the intercalation step 102. This inventive process produces lithium selective adsorbent 116 with superior reversible lithium capacity using water strip at 75° C. of greater than 3.2 g Li/L of finished adsorbent.

### EXAMPLES

The process for producing lithium selective adsorption/separation media using a stoichiometric amount of lithium is further illustrated by the following examples, which are provided for the purpose of demonstration rather than limitation.

### Example 1—Manufacturing an LADH Adsorbent Using a Stoichiometric Amount of Lithium from LiCl and LiOH·H₂O

Using a consistent charge of LiOH·H₂O, as the source of alkali, and varying the LiCl level, the Li:Al ratios were evaluated via testing the resulting LADH ([LiAl₂(OH)₆]X) adsorbent samples for reversible lithium loading performance, where X=Cl⁻, Br⁻, I⁻, SO₄²⁻, or NO₃⁻.

2Al(OH)₃+LiCl→[LiAl₂(OH)₆]Cl (Equation 4)

2Al(OH)₃+LiOH→[LiAl₂(OH)₆]OH (Equation 5)

The results indicated that the optimal charge of lithium per cubic foot of adsorbent (12% Al by dry weight) is between about 7 lb./cuft and about 9 lb./cuft (in LiCl equivalents). Due to the use of LiOH, this method introduced higher alkalinity than is normally employed for LADH formation. Higher alkalinity could theoretically result in loss of aluminum from the substrate; however, little aluminum loss was observed with this method, and in fact a more active LADH lithium adsorbent product was obtained.

### Example 2—Lithium Loading Results Using a Stoichiometric Amount of Lithium from LiCl and LiOH·H₂O

In this Example, samples of Al(OH)₃ imbibed ion exchange resin adsorbent-precursor were divided into five 50 mL portions and activated (lithium intercalated) separately while employing varied quantities and ratios of lithium salts to determine optimum Li levels required to achieve highly active lithium selective adsorbent. For each of the five intercalation reactions, in a silicon cup, 50 mL of Al(OH)₃ imbibed adsorbent precursor was slurried in 70 mL 17% NaCl brine. For each of the intercalation reactions, the same amount of LiOH·H₂O (2.5 g) was added, but the amount of LiCl added varied from 0.80 grams (g) to 5.04 g. Five intercalation reactions were performed in silicone cups, which were each loosely covered and charged with 2.50 g of LiOH·H₂O. The amount of LiCl was varied as follows: Sample 1, 5.04 g; Sample 2, 3.21 g; Sample 3, 2.41 g; Sample 4, 1.61 g and Sample 5, 0.80 g. Each of the slurries were gently stirred until fully mixed. The cups were again loosely covered and placed in a 95° C. oven. After 12 hours, the cups were removed from the oven, and the volume was returned to its initial volume with water. Each sample was transferred to its own 250 mL Pyrex beaker and titrated at between about 70° C. and about 75° C. using acetic acid to a lasting pH between about 5 and about 6.0. The samples were labeled “1” through “5” and submitted to 250 once hourly load/elute cycles at 75° C. using real geothermal brine at 250 mg/kg lithium content. The results, as shown in Table 4 and FIG. 3, demonstrated that with lithium salt loads of 7 lb./cuft and greater, maximum adsorption/desorption performance is achieved.

TABLE 4

| Sample | ~lb LiX/cuft | | | Li Salt | Media | Freshly Al(OH)₃ Imbibed* |
|---|---|---|---|---|---|---|
| Number | Sample Vol. | | Li Salt | lb/cuft | g/sample | g/L Li Cap. @ 250 Cycles |
| 1 | 9 | lb | LiOH H₂O | 3.12 | 2.50 | 3.3 |
| | 50 | mL | LiCl | 6.28 | 5.04 | |
| 2 | 7 | lb | LiOH H₂O | 3.12 | 2.50 | 3.3 |
| | 50 | mL | LiCl | 4.00 | 3.21 | |
| 3 | 6 | lb | LiOH H₂O | 3.12 | 2.50 | 3.1 |
| | 50 | mL | LiCl | 3.00 | 2.41 | |
| 4 | 5 | lb | LiOH H₂O | 3.12 | 2.50 | 3.2 |
| | 50 | mL | LiCl | 2.00 | 1.61 | |
| 5 | 4 | lb | LiOH H₂O | 3.12 | 2.50 | 1.7 |
| | 50 | mL | LiCl | 1.00 | 0.80 | |

*Starting with freshly Al(OH)₃ imbibed ion exchange resin beads

Sample 2 was cycled for an additional 3,000 cycles with no loss in load/elute performance.

### Example 3—Reintercalating a Spent LADH Adsorbent Using a Stoichiometric Amount of Lithium from LiCl and LiOH·H₂O

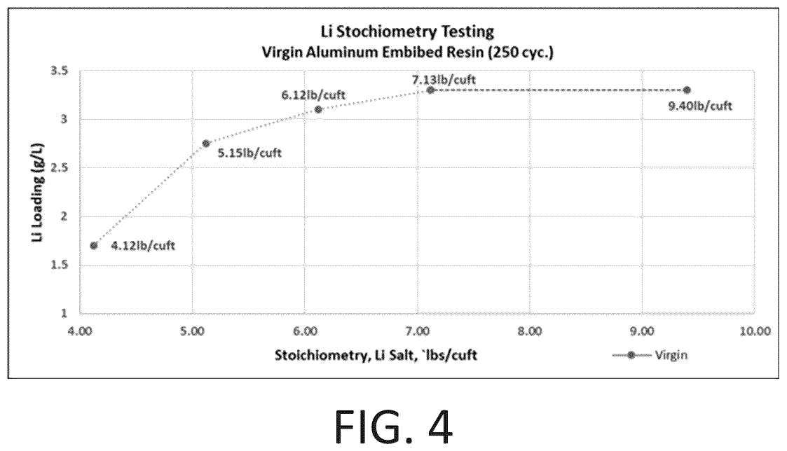

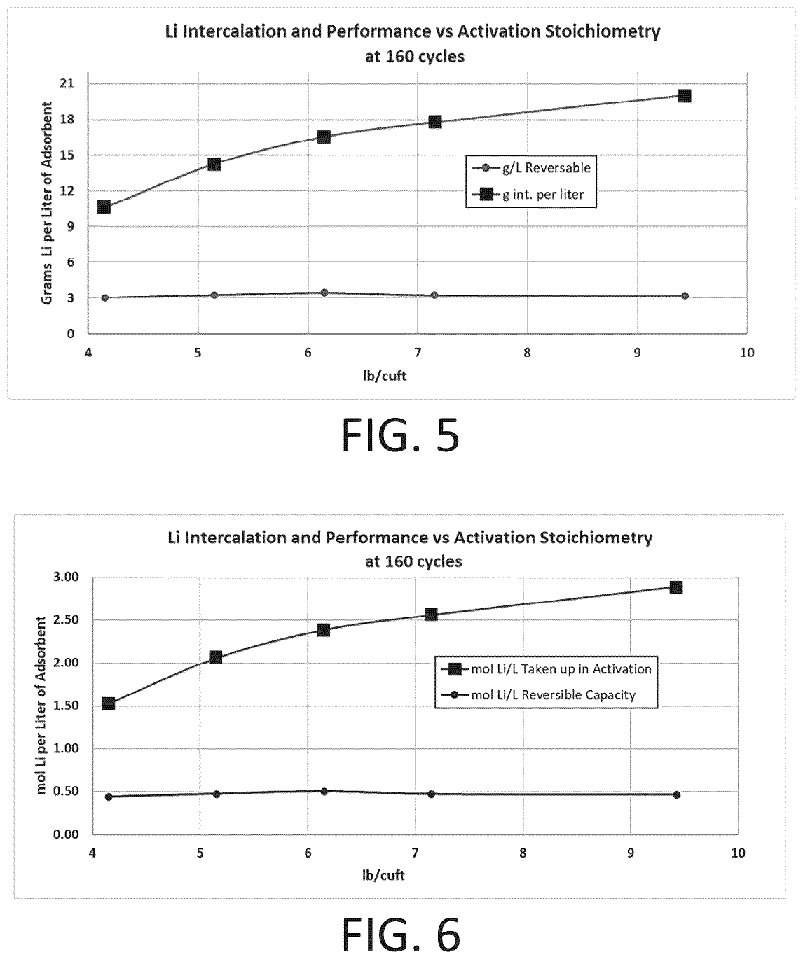

In this Example, optimized stoichiometry was used to determine the lithium used in reintercalation. A series of adsorbent samples was prepared using varied lithium loading in the activation step and spent or “strip damaged adsorbent” (5% active). At the end of a three-hour intercalation reaction with LiCl and LiOH·H₂O, the mother liquor was suctioned off and analyzed for lithium content. Since much of the lithium came from LiOH·H₂O and not LiCl, the results were calculated in LiCl equivalents to facilitate comparison to a LiCl/NaOH formulation. The resulting adsorbent samples were placed in the cycle tester for 160 cycles. The results showed that 3 grams (g) loading was achieved for samples prepared using a LiCl equivalent load of 4, 5, 6, 7, and 9 lb./cuft. The intercalation used increasing amounts of lithium as the lithium load increased. It is known that the adsorbent can take up increasing amounts of lithium as the challenge brine concentration increases. The adsorbent's lithium-to-aluminum ratio can increase from about 0.5:1 to much higher depending on the lithium concentration in the brine. However, as shown in FIGS. 4-5, the added lithium uptake did not produce a better adsorbent over the series. These results indicate that a regenerated adsorbent with similar lithium loads to adsorbents obtained from high-lithium-content reactions can be achieved using only ˜4 lb./cuft.

Tables 5 and 6 illustrate the lithium content (lb./cuft) for each sample of this Example 3. Compared to traditional manufacturing processes, the innovative process uses an optimized lithium to aluminum stoichiometry with a lower quantity of lithium.

TABLE 5
~5 lb./cuft

| bulk | Media | Media | | | | | | | Li |
|---|---|---|---|---|---|---|---|---|---|
| density | Mass | Vol. | LiCl | LiOH | Li Salt | Li Salt | Li Salt | Media | Capacity |
| kg/L | grams | mL | grams | grams | kg/mL | kg/cuft | lbs/cuft | ID | g/L |
| 1.4 | 35.5 | 50 | 1.6 | 2.5 | 0.08 | 2.34 | 5.14 | ESM | 3.3 |
| | | | | | | | | Polymer | |

TABLE 6

| | | | | | Freshly Al(OH)₃ | |
|---|---|---|---|---|---|---|
| | | | Li | | Imbibed* | Reintercalated** |
| | | | Salt | Media | g/L Li Cap. @ 500 | g/L Li Cap. @ 500 |
| | | | lb/cuft | g/sample | Cycles | Cycles |
| 9 | lb | LiOH | 3.12 | 5.01 | 3.3 | 3.2 |
| | | H₂O | | | | |
| 100 | mL | LiCl | 6.28 | 10.08 | | |
| 7 | lb | LiOH | 3.12 | 2.50 | 3.3 | 3.3 |
| 50 | mL | H₂O | | | | |
| | | LiCl | 4.00 | 3.21 | | |
| 6 | lb | LiOH | 3.12 | 2.50 | 3.1 | 3.1 |
| 50 | mL | H₂O | | | | |
| | | LiCl | 3.00 | 2.41 | | |
| 5 | lb | LiOH | 3.12 | 2.50 | 3.2 | 3.3 |
| 50 | mL | H₂O | | | | |
| | | LiCl | 2.00 | 1.61 | | |
| 4 | lb | LiOH | 3.12 | 2.50 | 1.7 | 3.2 |
| 50 | mL | H₂O | | | | |
| | | LiCl | 1.00 | 0.80 | | |

*Starting with freshly Al(OH)₃ imbibed ion exchange resin beads
**Starting with strip damaged adsorbent with Li capacity below 0.5

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted as a range whose lower limit is 25 and whose upper limit is 100. Additionally, it should be noted that where a range is given, every possible subrange or interval within that range is also specifically intended unless the context indicates the contrary. For example, if the specification indicates a range of 25 to 100, such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only, and decimal and fractional values (e.g., 46.7-91.3) should also be understood to be intended as possible subrange endpoints unless specifically excluded.

It should be understood that the exemplary embodiments described above should be considered in a descriptive sense only and not for purposes of limitation. Descriptions of features or aspects within these embodiments should typically be considered as available for other similar features or aspects in other embodiments.

While one or more embodiments have been described with reference to the figures, it will be understood by those of ordinary skill in the art that various changes in form and details may be made therein without departing from the scope of the inventive concept as defined by the following claims.

What is claimed is:

1. A process for producing a lithium selective adsorbent, the process comprising the steps of:
a. intercalating an adsorbent precursor or a spent lithium selective adsorbent using an intercalation reaction liquor comprising a stoichiometric amount of lithium to produce an intercalated layered aluminate adsorbent; and
b. neutralizing the intercalated layered aluminate adsorbent using an acid to produce the lithium selective adsorbent,
wherein the stoichiometric amount of lithium is less than about 10 lb. lithium per cubic foot of the lithium selective adsorbent.

2. The process of claim 1, wherein the stoichiometric amount of lithium is from about 4 lb. lithium per cubic foot of the lithium selective adsorbent to less than about 10 lb. lithium per cubic foot of the lithium selective adsorbent.

3. The process of claim 2, wherein the stoichiometric amount of lithium is between about 7 lb. lithium per cubic foot of the lithium selective adsorbent and about 9 lb. lithium per cubic foot of the lithium selective adsorbent.

4. The process of claim 3 wherein the stoichiometric amount of lithium is about 7 lb. lithium per cubic foot of the lithium selective adsorbent.

5. The process of claim 1, wherein the step a. of intercalating the adsorbent precursor or the spent lithium selective adsorbent further comprises intercalating the adsorbent precursor or the spent lithium selective adsorbent under alkaline conditions at a predetermined intercalation temperature for a predetermined amount of intercalation time, and wherein the intercalation reaction liquor comprises a lithium salt, an alkali or both in a brine.

6. The process of claim 5, wherein the alkaline conditions comprise an alkaline pH from about 7 to about 13.

7. The process of claim 6, wherein the alkaline pH is between about 9 and about 12.

8. The process of claim 5, wherein the stoichiometric amount of lithium comprises lithium from the lithium salt, the alkali, or both in the brine.

9. The process of claim 8, wherein the lithium salt comprises LiCl, LiBr, LiI, LiOH, Li₂SO₄, Li₂CO₃, LiNO₃, or a mixture thereof.

10. The process of claim 9, wherein the lithium salt is LiCl or LiOH.

11. The process of claim 8, wherein the alkali comprises an alkali hydroxide, an alkaline earth metal hydroxide, a strong base, a monoacid base, ammonia, or a mixture thereof.

12. The process of claim 11, wherein the alkali comprises KOH, NaOH, LiOH, or a mixture thereof.

13. The process of claim 12, wherein the alkali is NaOH or LiOH.

14. The process of claim 8, wherein the brine contains a majority of chloride salts.

15. The process of claim 8, wherein the brine comprises NaCl, NaBr, NaNO₃, KCl, KBr, or a mixture thereof.

16. The process of claim 15, wherein the brine is KCl or NaCl.

17. The process of claim 8, wherein the brine is NaCl or KCl, the lithium salt is LiCl or LiOH, and/or the alkali is NaOH or LiOH.

18. The process of claim 5, wherein the predetermined intercalation temperature is between about 25° C. and about 125° C.

19. The process of claim 18, wherein the intercalation temperature is between about 85° C. and about 105° C.

20. The process of claim 19, wherein the intercalation temperature is greater than about 100° C. to about 105° C.

21. The process of claim 5, wherein the predetermined amount of intercalation time is between about 0.375 hours and about 390 hours.

22. The process of claim 21, wherein the predetermined amount of intercalation time is greater than about 100 hours to about 390 hours.

23. The process of claim 21, wherein the predetermined amount of intercalation time is between about 1.5 hours and about 6 hours.

24. The process of claim 1, wherein the step b. of neutralizing the intercalated layered aluminate adsorbent further comprises neutralizing the intercalated layered aluminate adsorbent under acidic conditions at a predetermined neutralization temperature for a predetermined amount of neutralization time.

25. The process of claim 24, wherein the predetermined neutralization temperature is between about 25° C. and about 115° C.

26. The process of claim 25, wherein the neutralization temperature is between about 65° C. and about 80° C.

27. The process of claim 26, wherein the neutralization temperature is greater than 70° C. to about 80° C.

28. The process of claim 24, wherein the acidic conditions comprise an acidic pH from about 4.5 to about 7.

29. The process of claim 28, wherein the acidic pH is between about 5 and about 5.8.

30. The process of claim 28, wherein the acidic pH is between about 5.4 and about 6.5.

31. The process of claim 1, wherein the acid is a strong acid, a mineral acid, a sulfonic acid, a carboxylic acid, or a mixture thereof.

32. The process of claim 31, wherein the acid is hydrochloric acid, sulfuric acid, nitric acid, phosphoric acid, hydrobromic acid, perchloric acid, formic acid, acetic acid, or a mixture thereof.

33. The process of claim 32, wherein the acid is acetic acid.

34. The process of claim 1, wherein the acid has a concentration of between about 5% and about 100%.

35. The process of claim 24, wherein the predetermined amount of neutralization time is between about 0.03125 hours and about 16 hours.

36. The process of claim 35, wherein the predetermined amount of neutralization time is less than about 2 hours.

37. The process of claim 36, wherein the predetermined amount of neutralization time is between about 0.25 hours and about 1 hour.

38. The process of claim 1 further comprising the steps of:
a. intercalating an initial quantity of an alumina-based adsorbent precursor or a spent LADH lithium selective adsorbent under alkaline conditions at a predetermined intercalation temperature using the intercalation reaction liquor comprising the stoichiometric amount of lithium to produce the intercalated layered aluminate adsorbent and a post-intercalation reaction volume of a partially depleted intercalation reaction liquor, wherein the intercalation reaction liquor comprises a lithium salt and an alkali in a brine, wherein the intercalation temperature is between about 25° C. and about 125° C., and wherein the alkaline conditions comprises an alkaline pH from about 7 to about 13;
b. decanting the post-intercalation reaction volume of the partially depleted intercalation reaction liquor from the intercalated layered aluminate adsorbent to obtain a decanted intercalation reaction liquor;
c. neutralizing the intercalated layered aluminate adsorbent under acidic conditions using the acid at a predetermined neutralization temperature to produce the lithium selective adsorbent, wherein the neutralization temperature is between about 25° C. and about 115° C., and wherein the acidic conditions comprise a pH from about 4.5 to about 7;
d. augmenting the decanted intercalation reaction liquor from step b. by adding a makeup volume to reconstitute the pre-intercalation reaction volume from step a. and obtain an augmented intercalation reaction liquor; and
e. recycling the augmented intercalation reaction liquor from step d. in preparation for intercalating a subsequent quantity of the alumina-bearing adsorbent precursor or the spent LADH lithium selective adsorbent according to step a.;
wherein the stoichiometric amount of lithium is from about 4 lb. lithium per cubic foot of the lithium selective adsorbent to less than about 10 lb. lithium per cubic foot of the lithium selective adsorbent.

39. The process of claim 38, wherein the step e. of recycling the augmented intercalation reaction liquor further comprises filtering the augmented intercalation reaction liquor.

40. The process of claim 38, wherein the makeup volume comprises a makeup brine, a makeup lithium salt, a makeup alkali, or a mixture thereof.

41. The process of claim 40, wherein the makeup brine comprises a majority of chloride salts.

42. The process of claim 40, wherein the makeup brine comprises NaCl, NaBr, NaNO₃, KCl, KBr, or a mixture thereof.

43. The process of claim 40, wherein the makeup lithium salt comprises LiCl, LiBr, LiI, LiOH, Li₂SO₄, Li₂CO₃, LiNO₃, or a mixture thereof.

44. The process of claim 40, wherein the makeup alkali comprises KOH, NaOH, LiOH, or a mixture thereof.

45. The process of claim 40, wherein the makeup lithium salt is LiOH or LiCl, the makeup alkali is LiOH and NaOH, and/or wherein the makeup brine is KCl or NaCl.

46. The process of claim 38, wherein the process is performed at a chemical regeneration facility, an on-site mineral extraction facility, in a mobile reinteractation circuit, or within adsorbent columns of a direct lithium extraction circuit.

47. The process of claim 46, wherein the direct lithium extraction circuit comprises fixed beds, stirred tanks, pseudo- or simulated moving bed (SMB) circuits, or other DLE circuits.

48. A lithium aluminum double hydroxide (LADH) lithium selective adsorbent produced by the process of claim 1.
